(19) United States
(12) Patent Application Publication
(10) Pub. No.: US 2008/0280127 A1
(43) Pub. Date: Nov. 13, 2008

(54) Heat-Curable Molding Material Pellet Having Multilayer Structure

(75) Inventors: Shuichi Kitano, Kanagawa (JP); Yasuhiro Mino, Kanagawa (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/598,385

(22) PCT Filed: Feb. 23, 2005
(86) PCT No.: PCT/US2005/005751

§ 371 Date: Jul. 28, 2008

(30) Foreign Application Priority Data
Feb. 27, 2004 (JP) 2004-054048

(51) Int. Cl. B29B 9/16; C08J 3/24

(52) U.S. Cl. 428/327; 428/402.24; 264/347; 264/328.17

(57) ABSTRACT

A heat-curable molding material pellet comprising a heat-curable epoxy-containing material, a thermoplastic component and a curing agent for the epoxy-containing material, wherein the pellet has a multilayer structure comprising a core containing a first heat-curable component and a sheath containing a second heat-curable component, disposed in the periphery of the core.

### FIELD OF THE INVENTION

The present invention relates to heat-curable molding materials, in particular, to such materials in pellet form and, more particularly, to such pellets having a multiphase (e.g., multilayer) structure.

### BACKGROUND

Resin molding materials are generally used in the form of small tablet-like pellets. The pellets are produced by heat-melting a previously mixed and prepared resin starting material, extrusion-molding the melt into a strand form and cutting the obtained resin strand into pellet shaped pieces. By using such pellets, the cumbersome operation of blending and preparing a starting material for each molding operation can be dispensed with and a stable resin performance can be obtained. As a result, handling operations, such as the operation of supplying a starting material to the molding apparatus, can be facilitated and the quality of the molded article advantageously stabilized.

The pellet is sometimes used also in the production of heat-curable adhesive compositiona and sealers. In producing the pellet, the starting material is kneaded at a temperature lower than the curing reaction temperature of the heat-curable material. However, when all raw materials participating into the curing reaction are blended and pelletized, even if the pellet is prepared at a temperature lower than the heat-curing reaction temperature, a heat-curing reaction may proceed within the pellet that impairs the storage stability after the processing into a pellet product. In a worse case, the pellet may become a defective pellet before the processing into a final molded article shape. In order to prevent these problems, the pellet may be stored in a refrigerator, but this solution increases the cost of using such pellets.

One technique that has been used to solve these problems, is a method of preparing a first pellet containing a first curable material component and a second pellet containing a second curable material component, thereby separating the curable components from each other between pellets. These two kinds of pellets are mixed by a tumbler mixer or the like before molding and thereafter, supplied to an extrusion molding machine. However, when the kneading capacity of the extrusion molding machine is low, like an extruder where a single screw is used and the screw shape has only a function of merely transferring the resin, two kinds of pellets is sometimes insufficiently mixed to give a molded article having a concentration distribution and this may cause a serious defect in the final product. Furthermore, though only two kinds, the starting material pellets must be mixed before molding and this takes time and labor.

With respect to the technique for producing a pellet, for example, Japanese Unexamined Patent Publication (Kokai) No. 7-171828 discloses a pellet having a multilayer structure and Unexamined Patent Publication (Kokai) No. 2001-198918 discloses a method for producing a pellet having a multilayer structure. In the pellet disclosed in these publications, a highly tacky material is used for the core structure and a non-tacky material is used for the sheath layer. The resulting pellet has a core-sheath structure that prevents the tacky material from blocking.

### DISCLOSURE OF THE INVENTION

An object of the present invention is to provide a molding material pellet that is less likely to prematurely cure inside the pellet and will thereby exhibit enhanced storage stability. Another object of the present invention can be to provide such a pellet that is more easily and uniformly mixed even by a molding machine having a low kneading capacity.

According to one aspect of the present invention, a heat-curable molding material pellet is provided that comprises a heat-curable epoxy-containing material, a thermoplastic component and a curing agent for the epoxy-containing material. The pellet can have a multiphase structure comprising a core containing one heat-curable component and a sheath containing another heat-curable component, where the sheath is disposed at least partially around the periphery of the core. For example, the sheath can be formed so as to partially surround or encase the core (i.e., areas of the underlying core are exposed). The sheath may be formed so as to completely or at least mostly surround or encase the core (i.e., no, areas of the underlying core are exposed). The pellet can have a multilayer structure that is generally cylindrical in shape such as, for example, with the ends of the core being exposed. The multilayer structured pellet may also comprise alternating layers of the heat-curable components stacked, or otherwise disposed, one on top of the other such as, for example, where a core layer of one heat-curable component is sandwiched between two sheath layers of another heat-curable component. The pellet may be generally spherical or particle-like in shape such as, for example, with the core component being completely or at least mostly encased by the sheath component.

Alternatively, the pellet may have a multiphase structure comprising multiple cores of one heat-curable component embedded or dispersed in a sheath or matrix of another heat-curable component. A portion of one or more of the cores may be exposed (i.e., have a surface area that is not covered by the matrix material). Each of the multiple cores may also be completely or at least mostly surrounded by matrix material.

In one embodiment of the present invention, the heat-curable epoxy-containing material and the thermoplastic component are contained in the first heat-curable component, and the curing agent and the thermoplastic component are contained in the second heat-curable component.

In another embodiment of the present invention, the thermoplastic component and the curing agent are contained in the first heat-curable component, the thermoplastic component and the curing accelerator are contained in the second heat-curing component, and the epoxy-containing material is contained in either one or both of the first heat-curing component and the second heat-curing component. The curing agent can be a dicyandiamide, an organic acid hydrazide, an acid, an acid anhydride or a combination thereof. The curing accelerator can be an imidazole, a tertiary amine compound or a combination thereof.

The epoxy-containing material can contain an epoxidized thermoplastic resin and can serve also as a thermoplastic component. The epoxidized thermoplastic resin can contain an ethylene-glycidyl (meth)acrylate copolymer.

According to another aspect of the present invention, a method is provided for making an article by forming a plurality of pellets into a fully cured, partially cured or uncured article, where at least one, most or each of the pellets is a pellet as described above and claimed herein. The plurality of pellets can be mixed together with a mixing device that uses a single screw, has a relatively low kneading capacity or both.

The method can include melting/kneading the plurality of pellets to form a heat-curable molding material. The melting/kneading can occur at a temperature lower than the curing temperature of the heat-curable molding material, in order to obtain a partially cured or an uncured article. The partially cured or uncured article can then be formed into a mostly cured or fully cured article, at a temperature equal to or higher than the curing temperature of the heat-curable molding material. The thermoplastic component is a resin which can be melted/kneaded at a temperature lower thin the curing temperature of the heat-curable molding material.

Alternatively, the melting/kneading the plurality of pellets can occur at a temperature equal to or higher than the curing temperature of the heat-curable molding material, in order to directly obtain a mostly cured or fully cured article.

In an additional aspect of the present invention, an article is provided that is made according to any of the methods described above or claimed herein.

In the pellet, the heat-curable component is separated into a first heat-curable component and a second heat-curable component, so that unintended curing can be prevented from occurring during storage before the pellet is used as a molding material. Furthermore, by virtue of the multiphase (e.g., multilayer) structure of the present inventive pellets, with the curable components being in the form of a core and a sheath,, uniform mixing of the pellets can be easily attained even when a molding machine having a single screw and/or a relatively low kneading capacity is used.

### BRIEF DESCRIPTION OF THE DRAWINGS

FIG. 1a is schematic view of an exemplary apparatus that can be used to produce a multilayer pellet, according to the present invention;

FIG. 1b is a cross-sectional view of an exemplary multilayer strand or a multilayer pellet, according to the present invention;

FIG. 1c is a cross-sectional view of an alternative multilayer strand or pellet, according to the present invention;

FIG. 2 is a cross-sectional view of a die device that can be used to extrude a multilayer strand, according to the present invention;

FIG. 3 is a front view of the die device of FIG. 2;

FIGS. 4a and 4b are a schematic views showing the flow of the starting core material and sheath material in the die device of FIG. 2.

### DETAILED DESCRIPTION OF EXEMPLARY EMBODIMENTS

The present invention is described in detail below based on exemplary embodiments. However, the present invention is not limited to these specific embodiments.

### Epoxy-Containing Material:

The epoxy-containing material is a component that can be cured under heating and can impart heat curability to the molding material. A useful epoxy-containing material is an epoxy resin having at least one oxirane ring polymerizable by a ring-opening reaction. Such a material is called “epoxide” in the broad sense and includes monomolecular epoxide and polymer epoxide, and the epoxide can be aliphatic, alicyclic or aromatic. This material generally has two epoxy groups on average, preferably two or more epoxy groups, per one molecule. Such a material is particularly called “polyepoxide” and includes an epoxy-containing material where the functionality of epoxy is slightly smaller than 2.0, for example, 1.8. The average number of epoxy groups per one molecule is defined as a value obtained by dividing the number of epoxy groups in the epoxy- containing material by the total of epoxy molecules. The polymer epoxide includes a linear polymer having an epoxy group at the terminal (for example, diglycidyl ether of polyalkylene glycol) and a polymer having an oxylane unit as the skeleton (for example, polybutadiene polyepoxide). The molecular weight of the epoxy-containing material may vary in the range from about 58 to 100,000. Also, a mixture of various epoxy-containing materials may be used.

The useful epoxy-containing material contains a cyclohexeneoxide group and examples of such an epoxy-containing material include epoxycyclohexane carboxylates represented by 3,4-epoxycyclohexylmethyl-3,4-epoxycyclohexane carboxylate, 3,4-epoxy-2-methylcyclohexylmethyl-3,4-epoxy-2-methylcyclohexane carboxylate and bis(3,4-epoxy-6-methylcyclohexylmethyl) adipate.

The particularly useful epoxy-containing material is a monomer of diglycidyl ether such as diglycidyl ether of a polyvalent phenol (for example, diglycidyl ether of 2,2-bis(2,3-epoxypropoxyphenol)propane) obtained by reacting an excess polyvalent phenol with a chlorohydrin such as epichlorohydrin.

Many epoxy-containing materials are commercially available and can be used in the practice of the present invention. Examples of the epoxy-containing material which can be used include products commercially available from Japan Epoxy Resins Co., Ltd. under the product names of Epikote 1001, Epikote 1002, Fpikote 1003, Epikote 1004, Epikote 828 and Epikote 154.

The epoxy-containing material may also be an epoxidized thermoplastic resin. In this case, the epoxy-containing material also plays the role of thermoplastic component and the molding material before heat-curing can be melted. Typical examples of the epoxidized thermoplastic resin include an epoxidized ethylene-base thermoplastic resin. The epoxidized ethylene-base thermoplastic resin is preferably an ethylene-glycidyl (meth)acrylate copolymer. The ethylene-glycidyl (meth)acrylate copolymer is an epoxidized polyethylene and is usually obtained by copolymerizing an ethylene and a glycidyl (meth)acrylate. Furthermore, an epoxidized styrene-base thermoplastic resin or the like can also be used as the epoxidized thermoplastic resin.

For the epoxy resin epoxy-containing material, other than the above-described epoxidized thermoplastic resin, a liquid or solid epoxy resin may also be used, such as bisphenol A-type epoxy resin, bisphenol F-type epoxy resin, novolak-type epoxy resin and glycidylamine-type epoxy resin.

### Thermoplastic Component:

The pellet of the present invention contains a thermoplastic component so as to enable melt-molding and pelletization at a temperature lower than the heat-curing temperature. Representative examples of the thermoplastic resin useful as the thermoplastic component include a polyethylene, a polystyrene, an ethylene vinyl acetate copolymer, an ethylene-acrylic acid copolymer, an ethylene-glycidyl (meth)acrylate copolymer (this is also included in the epoxy-containing material), a polyester, a polyamide, a polyurethane, a polyvinyl alcohol and a polyvinyl acetal. The thermoplastic component is preferably a resin which can be melted/kneaded at a temperature lower than the curing temperature of the heat-curable component in the production of a molded article, more preferably a resin which can be melted/kneaded at a temperature 20° C. or more lower than the curing temperature of the heat-curable component. For example, in the case where the curing temperature of the epoxy-containing material is 140° C., a thermoplastic resin capable of melting/kneading at a temperature of 140° C. or less, preferably 120° C. or less, is selected. If the thermoplastic resin used can be melted/kneaded only at a temperature higher than the curing temperature of the epoxy-containing heat-curing material, the heat-curable pellet cannot be produced without involving heat curing. Furthermore, in the production of a molded article from a multiphase (e.g., multilayer) pellet, a molding temperature higher than the curing temperature is required and the heat curing reaction proceeds in the molding machine.

The thermoplastic component can generally used in an amount of 50 to 400 parts by parts per 100 parts of the epoxy-containing material, but this is not particularly limited. If the amount of the thermoplastic component is too small, the molded article after curing tends to be fragile, whereas if it is excessively large, the curing by thermal crosslinking may result insufficiently.

### Curing Agent for Epoxy-Containing Material:

The curing agent is not limited as long as it can cause a reaction of the epoxy group under heating to obtain a cured product. Accordingly, examples of the curing agent include amine compounds such as dicyandiamide, compounds having a carboxyl group (including an acid anhydride) within the molecule, salts of Lewis acid or Broensted acid, imidazoles, organic acid dihydrazides, and tertiary amine compounds such as urea derivative. Among these curing agents, the imidazoles and tertiary amine compounds each is usually not used alone and only when used in combination with a curing agent such as dicyandiamide, organic acid dihydrazide, acid or acid anhydride, exerts the function as a curing accelerator. Representative examples of the organic acid dihydrazide include adipic acid dihydrazide. Representative examples of the acid and acid anhydride include highly acidic rosin, phthalic anhydride and trimellitic anhydride. Representative examples of the imidazoles include 2,4-diamino-6-(2′-methylimidazolyl-(1′))-ethyl-s-triazine-isocyanurate, 2-phenyl-4-benzyl-5-hydroxyethylimidazole and nickel imidazole phthalate. Representative example of the tertiary amine compound such as urea derivative include 3-phenyl-1,1-dimethylurea and p-chlorophenyl-1,1-dimethylurea.

The amount of the curing agent is not particularly limited as long as the epoxy- containing material can be cured, and the curing agent may be used in a commonly employed amount.

### Optional Additives:

In addition to the above-described components, the heat-curable molding pellet of the present invention may contain, if desired, additives such as filler, colorant, antioxidant, ultraviolet stabilizer, plasticizer, softening agent, lubricant and coupling agent.

The epoxy-containing heat-curable material which can be used for the pellet (masterbatch) having a multilayer structure of the present invention is described, for example, in National Publication of Translated Version (Kohyo) No. 9-505335 and Kokai Nos. 2000-192013 and 2002-121351.

Separation of Material into First Curable Component and Second Curable Component:

The heat-curable molding material pellet of the present invention can have a multiphase (e.g., a multilayer) structure comprising a core containing a first heat-curable component and a sheath containing a second heat-curable component, where the sheath is disposed at least partially or fully around the periphery of the core. The heat-curable epoxy-containing material, the thermoplastic component, the curing agent for the epoxy-containing material and, if present, the curing accelerator each may be contained in either curing component as long as these elements are separated so as not to allow, or at least significantly delay, the proceeding of curing reaction during storage.

For example, in one embodiment, the epoxy-containing material is contained in the first curable component and the curing agent is contained in the second curable component. In this example, the first curable component contains the epoxy-containing material and the thermoplastic component to enable the melt-molding. The second curable component contains the curing agent and may contain the curing accelerator, if present, and the thermoplastic component. When such a combination is employed, the curing reaction can be slowed or halted so as not to proceed before the melting/kneading of the pellet and the storage stability is enhanced.

In a second example, in the case of using a curing agent and a curing accelerator in combination for the heat curing of the epoxy-containing material, the curing agent is contained in the first curable component and the curing accelerator is contained in the second curing component. More specifically, the first curing component contains the epoxy-containing material, the thermoplastic component and the curing agent and the second curable component contains the epoxy-containing material, the thermoplastic component and the curing accelerator.

### Production of Multilayer Pellet:

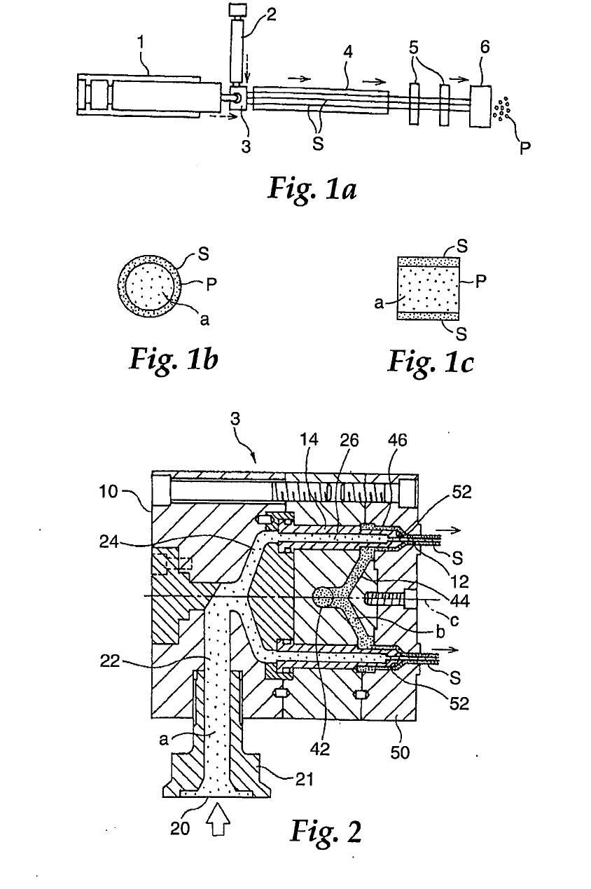

The production method itself of a multilayer pellet is known and the pellet having a multilayer structure of the present invention can be produced by using a method and an apparatus for producing a multilayer pellet disclosed, for example, in Kokai No. 2001-198918. FIG. 1 shows a schematic view of an apparatus for producing a multilayer pellet, and a cross-sectional structure of the produced multilayer stand (state before cutting into pellets) or multilayer pellet. As shown in FIG. 1(a), an extruder 1 for core material and an extruder 2 for sheath material are connected from orthogonal directions with each other.

In the core material extruder 1, a resin starting material for the core material is supplied and melted under heating. In the sheath material extruder 2, a resin starting material for the sheath material is supplied and melted under heating. The materials melted under heating are supplied to a die device 3.

From the die device 3, a plurality of multilayer stands S are extruded in parallel with each other while constituting a cylindrical surface. As shown in FIG. 1(b), the multilayer strand S has a cross-sectional shape such that a core material a is disposed in the center and the outer periphery thereof is covered by a sheath material b in a relatively small thickness. The extrusion-molded multilayer strand S is transferred to a cooling tank 4 and solidified by cooling. The multilayer strand S outgoing from the cooling tank is transferred to a pelletizer 6 through a water-removing device 5. In the pelletizer 6, the multilayer strand S is finely cut to obtain multilayer pellets P. The cross-sectional structure of the multilayer pellet is, as shown in FIG. 1(b), also a core-sheath structure consisting of a core material a and a sheath material b.

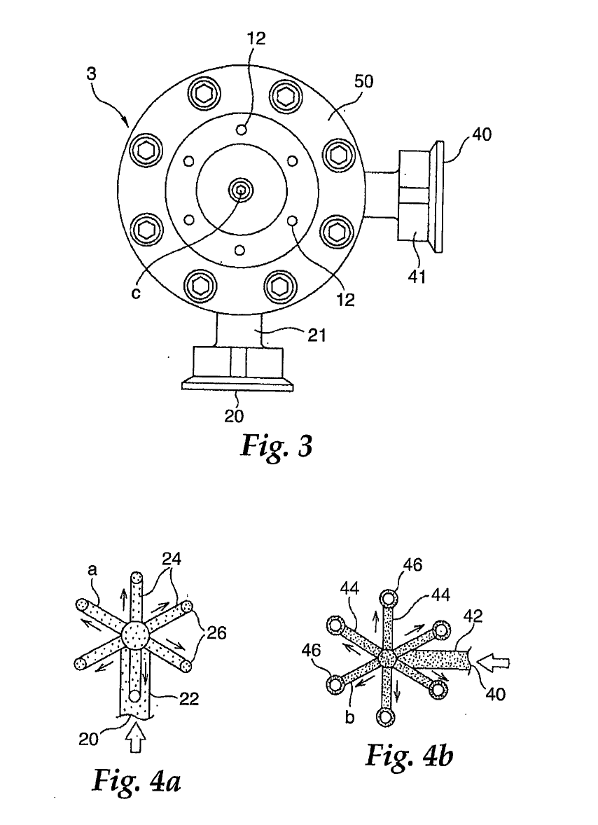

As shown in FIGS. 2 and 3, the die device has a nearly cylindrical body 10. As particularly shown in FIG. 3, on the cylindrical peripheral face of the body 10, a core material supply cylinder 21 and a sheath material supply cylinder 41 are provided at positions orthogonal with each other. The end face of the core material supply cylinder serves as a core material supply port 20 and the end face of the sheath material supply cylinder 41 serves as a sheath material supply port 40. The core material supply port 20 is connected with the core material extruder 1 and the sheath material supply port is connected with the sheath material extruder 2.

On the distal end face of the body 10, extrusion ports 12 are disposed in a plurality of portions along the circumference. In the Figure, extrusion ports 12 are disposed in 6 portions at equal intervals. The line extending from the center of the circumference constituted by extrusion ports 12 toward the direction orthogonal to the face containing the circumference represents a center axis C. As shown in FIG. 2, a core material supply path 22, 24 and 26 starting from the core material supply port 20 and reaching to each extrusion port 12 and a sheath material supply path 42, 44 and 46 starting from the sheath material supply port 40 (see FIG. 3) and reaching to each extrusion port 12 are provided. The core material supply path is constituted by a relatively big main supply path 22 extending from the core supply port 20 toward the center axis C in the center of the body 10 and thereafter extending along the center axis C toward the front extrusion port 12 side, a plurality of radial direction supply paths 24 smaller than the main supply path 22, continuing from the main supply path 22 and extending along the conical face toward the slightly oblique front side in the radial directions, and parallel supply paths 26 continuing from the radial direction supply paths 24, extending toward the front side in parallel with the center axis C and reaching to the extrusion port 12.

The parallel supply path 26 is passing through the center of a cylindrical core material nozzle 14 removably embedded in the body 10, and extending toward the extrusion port 12. The distal end of the core material nozzle 14 is narrowed by tapering and inserted inside a holder hole 52 of an extrusion disk 50 disposed on the front face of the body 10. On the extrusion disk 50, a holder hole 52 is provided at each extrusion-molding part and the distal end of the holder hole 52 works as the extrusion port 12. The sheath supply path is constituted by a relatively big main supply path 42 extending from the sheath material supply port 40 toward the center axis C in the center of the body 10 and thereafter extending along the center axis C toward the front extrusion port 12 side, radial direction supply paths 44 smaller than the main supply path 42, continuing from the main supply path 42 and extending toward slightly oblique front side in the radial directions, and parallel supply paths 46 continuing from radial direction supply paths 4, extending toward the front side in parallel with the center axis C and reaching to the extrusion port 12.

The main supply path 42 for the sheath material is disposed in the front side closer to the extrusion port 12 than the main supply path 22 for the core material. The radial direction supply path 44 for the sheath material is continuing to the inner periphery of the core material nozzle 14. The parallel supply path 46 for the sheath material is extending through the gap between the outer periphery of the core material nozzle 14 and the holder hole 52 and reaching to the extrusion port 12. In the gap between the outer diameter at the distal end of the core material nozzle 14 and the holder hole 52, the thickness of the sheath material b is changed and the ratio in the thickness between the core material a and the sheath material b is determined. The thickness of the sheath material b can be controlled by adjusting the position of the core material nozzle 14 to the forward or backward direction in parallel to the center axis C.

The core material a and the sheath material b supplied in the melted state to the die device 3 from extruders 4 and 2 flow in the core supply path 20 to 26 and in the sheath material supply path 40 to 46, respectively. In the extrusion port 12, the core material a flows in the center and the sheath material b flows in the outer periphery, whereby a multilayer strand S having a so-called core-sheath structure is formed. In the core material supply path 20 to 26, the core material a delivered from the main supply path 22 to the position of the center axis C is equally distributed to each radial direction supply path 24 from the position of the center axis C. Also in the sheath supply path 40 to 46, the sheath material b delivered from the main supply path 42 to the position of the center axis C is equally distributed to each radial direction supply path 44 from the position of the center axis C.

As shown in FIG. 4, the core material a and the sheath material b both are delivered to the parallel supply paths 26 and 46 in the state of being equally distributed by the radial direction supply paths 24 and 44, so that the amounts of core material a and sheath material b supplied each can be prevented from causing difference among the extrusion molding parts at a plurality of portions, or the ratio in the thickness between the core material a and the sheath material b of the multilayer strand S can be prevented from fluctuating. In the extrusion disk 50 part, the core material a and the sheath material b outflowed from the parallel supply paths 26 and 46 in the inner and outer peripheries of the core material nozzle 14 are converged at the distal end of the core material nozzle 14, the outer diameter is adjusted by the holder hole 52 at the extrusion port 12, and a multilayer strand S where the core material a is covered with the sheath material b at a constant thickness ratio is formed.

The die device 3 can be optionally modified to extrude a plurality of multilayer stands S having alternating layers of the heat-curable components stacked, or otherwise disposed, one on top of the other. For example, as shown in FIG. 1(c), a core layer a of one heat-curable component can be sandwiched between two sheath layers s of another heat-curable component. As described above, this multilayered strand S can be transferred to a cooling tank 4, through a water-removing device 5 and then finely cut into alternative multilayer pellets P by the pelletizer 6. The cross-sectional structure of the resulting multilayer pellet is also as shown in FIG. 1(c).

The multilayer strand S extrusion-molded by the die device 3 is delivered such that according to the disposition structure of extrusion ports 12, 6 multilayer strands S form a cylinder. As shown in FIG. 1, the plurality of multilayer strands S enter a cooling tank 4 while keeping the parallel state and are cooled during running in the state of being immersed in water. Alternatively, the strands S can be brought into contact with each other so as to form a bundle of the strands S, with the strands remaining straight and parallel to each other or with the strands being twisted together in the form a rope or yarn, before entering the cooling tank 4. In either case, the resulting bundle of strands S, or each multilayer strand S, outgoing from the cooling tank 4 can be subjected to removal of water adhering to the surface in a water-removing device S and then cut by a pelletizer 6 to give multilayer pellets. Pellets made from such a bundle of strands S can be seen as having multiple cores of one heat-curable component embedded or dispersed in a sheath or matrix of another heat-curable component.

### Production of Molded Article:

In the multilayer pellet of the present invention produced as above, the curable components are separated and therefore, a curing reaction does not proceed during storage. Furthermore, the curable components are separated by a core-sheath structure within a pellet, so that when a molded article is produced by using this pellet, the components can be satisfactorily uniformly mixed even by a molding machine having a relatively low kneading capacity and the molded article can be free of a problem in the quality. In this way, the molded article can be used as a material supplied to a general molding machine, particularly a single screw extrusion-molding machine having low kneading capacity. The pellet supplied to the hopper of the extrusion-molding machine is melt-molded at a temperature lower than the heat-curing temperature, whereby an uncured molded article can be obtained. Also, the pellet may be further heated to a temperature higher than the heat-curing temperature in the molding machine to obtain a cured molded article.

In addition to the above-described extrusion molding, the molded article may also be produced by other molding methods such as injection molding.

### EXAMPLES

The pellet (master batch) having a core-sheath double layer structure of the present invention was produced by a multilayer pellet producing apparatus having the above-described constitution (produced by Sumika Color Co., Ltd.). The core material and the sheath material each had the following component composition.

TABLE 1
Component Composition of Example 1
Core Side

| | | |
|---|---|---|
| Epoxy-containing | CG5001 | 50 parts by weight |
| material, thermo- | (ethylene-glycidyl | |
| plastic component | methacrylate copolymer) | |
| Epoxy-containing | Epikote 1001 | 10 parts by weight |
| material | (solid epoxy resin) | |
| Curing agent | KE604 | 10 parts by weight |
| | (highly acidic rosin) | |
| Filler | Whiton SB | 20 parts by weight |
| | (calcium carbonate) | |
| Epoxy-containing | HBE100 | 10 parts by weight |
| material | (liquid epoxy resin) | |

Sheath Layer

| | | |
|---|---|---|
| Epoxy-containing | CG5001 | 10 parts by weight |
| material, thermo- | (ethylene-glycidyl | |
| plastic component | methacrylate copolymer) | |
| Curing accelerator | 2MA-OK | 1 part by weight |
| | (imidazole compound) | |
| Colorant | color pellet (blue) | 0.1 part by weight |

### In Tables,

CG5001 is an ethylene-glycidyl methacrylate copolymer containing 18 mass % of glycidyl methacrylate (CG5001, trade name, produced by Sumitomo Chemical Co., Ltd.),
Epikote 1001 is an epoxy resin having an epoxy equivalent of about 450 (Epikote 1001, trade name, produced by Japan Epoxy Resins Co., Ltd.)
KE604 is a carboxyl group-containing rosin having an acid value of 240 mg KOH/g (KE604, trade name, produced by Arakawa Chemical Industries, Ltd.),
Whiton SB is calcium carbonate (filler, Whiton SB, trade name, produced by Shiraishi Calcium Kaisha, Ltd.),
HBE100 is a hydrogenated bisphenol A-type diglycidyl ether having an epoxy equivalent of about 215 (HBE100, trade name, produced by New Japan Chemical Co., Ltd.),
2MA-OK is an imidazole-base derivative (curing accelerator, 2MA-OK, trade name, produced by Shikoku Corp.), and
Color pellet is a blue pellet based on low-density polyethylene (PEX3160, trade name, produced by Tokyo Printing Ink Mfg. Co., Ltd).

In this Example, an epoxy-containing material, a thermoplastic component, a curing agent and a filler were contained as the core material, and an epoxy-containing material, a curing accelerator and a colorant were contained as the sheath material. Thus, a curing agent and a curing accelerator were separated. In the sheath material side, a colorant was added to clearly distinguish the components. The obtained pellet had a diameter of 3 mm and a length of 5 mm and the weight average of 30 pieces of the pellet was 0.679 g.

### Comparative Example 1

A pellet having a core-sheath structure was produced thoroughly in the same manner as in Example 1 except that 2MA-OK (curing accelerator) was contained in the core material side but not in the sheath material side. Thus, an epoxy-containing material, a curing agent and a curing accelerator were introduced into the core material side. The component composition is shown in Table 2 below.

TABLE 2
Component Composition of Comparative Example 1
Core Side

| | | |
|---|---|---|
| Epoxy-containing | CG5001 | 50 parts by weight |
| material, thermo- | (ethylene-glycidyl | |
| plastic component | methacrylate copolymer) | |
| Epoxy-containing | Epikote 1001 | 10 parts by weight |
| material | (solid epoxy resin) | |
| Curing agent | KE604 | 10 parts by weight |
| | (highly acidic rosin) | |
| Filler | Whiton SB | 20 parts by weight |
| | (calcium carbonate) | |
| Epoxy-containing | HBE100 | 10 parts by weight |
| material | (liquid epoxy resin) | |
| Curing accelerator | 2MA-OK | 1 part by weight |
| | (imidazole compound) | |

Sheath Layer

| | | |
|---|---|---|
| Epoxy-containing | CG5001 | 10 parts by weight |
| material, thermo- | (ethylene-glycidyl | |
| plastic component | methacrylate copolymer) | |
| Colorant | color pellet (blue) | 0.1 part by weight |

### Comparative Example 2

A first pellet (single layer) comprising the core material of Example 1 and a second pellet (single layer) comprising the sheath material of Example 1 were separately produced by a pilot extruder. The obtained pellets had the same shape and the same dimension as those of the pellet in Example 1.

### 1. Evaluation of Pellet

1.1 Evaluation of Kneadability

A test for comparing the kneadability between the multilayer pellet of Example 1 and the pellet of Comparative Example 2 was performed. The multilayer pellet of Example 1 was extrusion-molded by a single screw extruder attached to a Brabender mixer, which was low in the kneading capacity and had only a material-transferring function. The single screw extruder had a constitution of L/D (length/diameter ratio)=20 and diameter=20 cm. The obtained extrusion product had a uniformly pale blue color, revealing that the kneading was successfully performed.

On the other hand, the first pellet and the second pellet of Comparative Example 2 were mixed at a weight ratio of 100:11.1 (90:10 wt % ratio) in a tumbler mixer. Thereafter, an extrusion product was produced in the same manner as in the pellet of Example 1. The obtained extrusion product had a mottled blue color, revealing that the kneading was not successfully performed.

1.2 Melt Flow Rate (MFR)

The pellet of Example 1 and the pellet of Comparative Example 1 were evaluated by the melt flow rate as a measure for judging the progress of curing when stored at a temperature lower than the heat-curing temperature. The melt flow rate was measured according to JIS K7210 at a test temperature of 100° C. under a load of 5 kg. The measurement was performed immediately after the production of pellet (initial), after standing at room temperature (for 2 weeks and for 1 month) and after accelerated aging at 40° C. (for 2 weeks and for 1 month). The results are shown in Table 3 below.

TABLE 3

| | | Example 1 | | Comparative Example 1 | |
|---|---|---|---|---|---|
| | | MFR | Retention | MFR | Retention |
| | | (g/10 min) | (%) | (g/10 min) | (%) |
| Initial | | 156 | — | 122.3 | — |
| Room | 2 weeks | 154.1 | 98.8% | 112.2 | 91.7% |
| temperature | 1 month | 144.4 | 92.6% | 92.4 | 75.6% |
| 40° C. | 2 weeks | 88.6 | 56.8% | 35.3 | 28.9% |
| | 1 month | 44.5 | 28.5% | 5.3 | 4.3% |

In all measurements, the pellet of Example 1 exhibited an MFR higher than the pellet of Comparative Example 1. In particular, the pellet of Example 1 exhibited a high MFR significantly exceeding 100 (g/10 min) even after storage at room temperature for 1 month, but the MFR of the pellet of Comparative Example 1 decreased to less than 100 (g/10 min). From these results, it is seen that the multilayer pellet of the present invention where the curing agent and the curing accelerator are separated does not undergo heat-curing at a temperature lower than the curing temperature and has high storage stability.

1. A heat-curable molding material pellet comprising a heat-curable epoxy-containing material, a thermoplastic component and a curing agent for said epoxy-containing material, wherein said pellet has a multiphase structure comprising a core containing a first heat-curable component and a sheath containing a second heat-curable component, disposed at lest partially around the periphery of said core.

2. The heat-curable molding material pellet as claimed in claim 1, wherein said epoxy-containing material and said thermoplastic component are contained ins aid first heat-curable component and said curing agent and said thermoplastic component are contained in said second heat-curable component.

3. The heat-curable molding material pellet as claimed in claim 1, wherein said curing agent and said thermoplastic component are contained in said first heat-curable component and said epoxy-containing material and said thermoplastic component are contained in said second heat-curable component.

4. The heat-curable molding material pellet as claimed in claim 1, wherein said thermoplastic component and said curing agent are contained in said first heat-curable component, said thermoplastic component and said curing accelerator are contained in said second heat-curing component, and said epoxy-containing material is contained in either one or both of said first heat-curing component and said second heat-curing component.

5. The heat-curable molding material pellet as claimed in claim 4, wherein said curing agent is a dicyandiamide, an organic acid hydrazide, an acid, an acid anhydride or a combination thereof, and said curing accelerator is an imidazole, a tertiary amine compound or a combination thereof.

6. The heat-curable molding material pellet as claimed in claim 1, wherein said epoxy-containing material contains an epoxidized thermoplastic resin and serves as a thermoplastic component.

7. The heat-curable molding material pellet as claimed in claim 6, wherein said epoxidized thermoplastic resin contains an ethylene-glycidyl (meth)acrylate copolymer.

8. The heat-curable molding material pellet as claimed in claim 1, wherein said sheath partially, mostly or completely surrounds said core.

9. The heat-curable molding material pellet as claimed in claim 1, wherein said pellet has a multilayer structure that is generally cylindrical in shape, with said core having one or both ends exposed.

10. The heat-curable molding material pellet as claimed in claim 1, wherein said pellet has a multilayer structure comprising alternating layers of said heat-curable components disposed one on top of the other.

11. The heat-curable molding material pellet as claimed in claim 10, wherein said core comprises a core layer of said first heat-curable component, said sheath comprises two sheath layers of said second heat-curable component, and said core layer is sandwiched between said sheath layers.

12. The heat-curable molding material pellet as claimed in claim 1, wherein said pellet is generally spherical or particle-like in shape, with said core being completely or at least mostly encased by said sheath.

13. The heat-curable molding material pellet as claimed in claim 1, wherein said sheath is in the form of a matrix, and said pellet comprises multiple cores of said first heat-curable component embedded in said matrix.

14. The heat-curable molding material pellet as claimed in claim 13, wherein a portion of one or more of said cores is exposed.

15. The heat-curable molding material pellet as claimed in claim 13, wherein each of said cores is completely or at least mostly surrounded by said matrix.

16. A method of making an article comprising:
forming a plurality of pellets into a fully cured, partially cured or uncured article, wherein at least one of the pellets is a heat curable molding material pellet as claimed in claim 1.

17. The method as claimed in claim 16, wherein most or each of the pellets is the heat curable molding material pellet.

18. The method as claimed in claim 16 further comprising:
mixing the plurality of pellets with a mixing device that uses a single screw, has a relatively low kneading capacity or both.

19. The method as claimed in claim 16 further comprising:
melting/kneading the plurality of pellets to form a heat-curable molding material, said melting/kneading occurring at a temperature lower than the curing temperature of the heat-curable molding material,
wherein the thermoplastic component is a resin which can be melted/kneaded at a temperature lower than the curing temperature of the heat-curable molding material, and a partially cured or an uncured article is obtained from said method.

20. The method as claimed in claim 16 further comprising:
melting/kneading the plurality of pellets to form a heat-curable molding material, said melting/kneading occurring at a temperature lower than the curing temperature of the heat-curable molding material;
forming the heat-curable molding material into a partially cured or uncured article; and
forming the partially cured or uncured article into a mostly cured or fully cured article and at a temperature equal to or higher than the curing temperature of the heat-curable molding material,
wherein the thermoplastic component is a resin which can be melted/kneaded at a temperature lower than the curing temperature of the heat-curable molding material.

21. The method as claimed in claim 16 further comprising:
melting/kneading the plurality of pellets to form a heat-curable molding material, said melting/kneading occurring at a temperature equal to or higher than the curing temperature of the heat-curable molding material;
wherein a mostly cured or fully cured article is obtained from said method.

22. An article made according to the method as claimed in claim 16.
